(19) United States
(12) Patent Application Publication
(10) Pub. No.: US 2006/0261602 A1
(43) Pub. Date: Nov. 23, 2006

(54) Inertia catch for door latches

(76) Inventors: Krystof P. Jankowski, Waterford, MI (US); Roman Cetnar, Newmarket (CA); Zahid Wazir, Newmarket (CA); Gavin Winch, Anten Mills (CA)

Correspondence Address: CLARK HILL, P.C., 500 WOODWARD AVENUE, SUITE 3500, DETROIT, MI, 48226, US

(21) Appl. No.: 11/437,068

(22) Filed: May 19, 2006

Related U.S. Application Data
(60) Provisional application No. 60/682,982, filed on May 20, 2005.
(60) Provisional application No. 60/682,981, filed on May 20, 2005.

(51) Int. Cl. E05C 3/06

(52) U.S. Cl. 292/216

(57) ABSTRACT

A latch assembly is provided for selectively engaging a striker in order to latch a door to a motor vehicle body. The latch assembly includes a housing. A ratchet is rotatably mounted to the housing for movement between an engaged position engaging the striker and a release position. A pawl is rotatably mounted to the housing and engageable with the ratchet to retain the ratchet in the engaged position. An inertia catch is coupled to the housing and is operably connected to the pawl for preventing the pawl from moving out of engagement with the ratchet in the event of a motor vehicle impact.

### REFERENCE TO CROSS-RELATED APPLICATIONS

This application claims the benefit of and priority to U.S. Provisional Application Ser. No. 60/682,981, entitled “Inertia Catch for Door Latches” and filed May 20, 2005, and U.S. Provisional Application Ser. No. 60/682,982, entitled “Safety Mechanism for Vehicle Door Latch Systems” and filed May 20, 2005.

### FIELD OF THE INVENTION

The invention relates to a latch assembly for selectively locking a motor vehicle door. More particularly, the invention relates to a latch assembly having an inertia lever for preventing a ratchet from releasing a striker in the event of a motor vehicle impact.

### DESCRIPTION OF RELATED ART

Motor vehicles include hinged doors for selectively providing access to motor vehicle passenger or cargo compartments. Typically, a latch mechanism is coupled between one of the doors and a motor vehicle body for releasably locking the door in a closed position. A release mechanism is typically coupled to the latch mechanism for locking and unlocking the latch mechanism. It remains desirable to provide a mechanism for preventing the latch mechanism from unlocking during a side impact of the motor vehicle.

### SUMMARY OF THE INVENTION

According to one aspect of the invention, a latch assembly selectively engages a striker for latching a door to a motor vehicle body. A ratchet is rotatably mounted to the housing for movement between an engaged position engaging the striker and a release position. A pawl is rotatably mounted to the housing and is engageable with the ratchet to retain the ratchet in the engaged position. An inertia catch is coupled to the housing and operably coupled to the pawl for preventing the pawl from moving out of engagement with the ratchet in the event of a motor vehicle impact.

According to another aspect of the invention, a latch assembly selectively engages a striker for latching a door to a motor vehicle body. The latch assembly includes a housing, a ratchet rotatably mounted to the housing for movement between an engaged position engaging the striker and a release position, and a pawl rotatably mounted to the housing and engageable with the ratchet to retain the ratchet in the engaged position. An auxiliary pawl lever is rotatably mounted to the housing and operably connected to the pawl for moving the pawl out of engagement with the ratchet. An inertia lever is rotatably mounted to the housing and includes a lip engageable with the auxiliary pawl lever in the event of a motor vehicle impact to prevent the auxiliary pawl lever from moving the pawl out of engagement with the ratchet.

According to yet another aspect of the invention, a latch assembly includes a housing, a ratchet rotatably mounted to the housing for movement between an engaged position engaging the striker and a release position, and a pawl rotatably mounted to the housing and engageable with the ratchet to retain the ratchet in the engaged position. A plunger is operably coupled to the pawl and movable between a rest position and an extended position in which the pawl is moved out of engagement with the ratchet to allow the ratchet to move into the release position. An inertia lever is engageable with the plunger in response to a motor vehicle impact for preventing the plunger from moving into the extended position.

### BRIEF DESCRIPTION OF THE DRAWINGS

The present invention will be readily appreciated as the same becomes better understood by reference to the following detailed description when considered in connection with the accompanying drawings wherein:

FIG. 1 is a fragmentary, perspective view of a motor vehicle including a latch assembly according to the invention fixedly mounted along a door;

FIG. 2 is a perspective view of the latch assembly including a ratchet engaging a striker and a pawl abutting the ratchet along a first side of a housing;

FIG. 3 is a perspective view of the latch assembly including the pawl retaining the ratchet in a release position;

FIG. 4 is an exploded, perspective view of the latch assembly including an auxiliary pawl lever disposed along a second side of the housing;

FIG. 5 is an elevational, side view including the auxiliary pawl lever, which is coupled to the pawl, and an inertia lever disposed along the second side of the housing;

FIG. 6 is an elevational, side view of the second side of the housing including the auxiliary pawl lever pivoted away from the inertia lever;

FIG. 7 is an elevational, side view of the second side of the housing including a lip of the inertia lever engaging a projection of the auxiliary pawl lever during a motor vehicle impact;

FIG. 8 is a perspective view of a latch assembly according to a second embodiment of the invention including the inertia lever abutting a first end of a plunger;

FIG. 9 is a perspective view of the latch assembly including the first end of the plunger clearing the hook of the inertia lever to rotate the auxiliary pawl lever and allow movement of the ratchet into the release position; and

FIG. 10 is a perspective view of the latch assembly including the hook of the inertia lever engaging the first end of the plunger to prevent rotation of the auxiliary pawl lever.

### DETAILED DESCRIPTION OF THE PREFERRED EMBODIMENTS

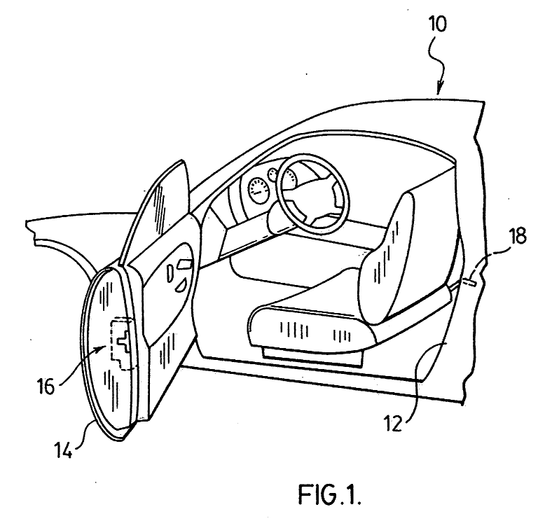

Referring to FIG. 1, a motor vehicle, generally indicated at 10, includes a body portion 12 and a door 14 pivotally hinged to the body portion 12 for movement between an open position and a closed position. A latch assembly, generally shown at 16, is fixedly mounted to the door 14 and selectively engages a striker 18 mounted along the body portion 12. A detailed description of the structure and function of the latch assembly 16 is disclosed in Applicant's U.S. patent application Ser. No. 11/007,946 filed on Dec. 9, 2004, which is incorporated herein by reference in its entirety.

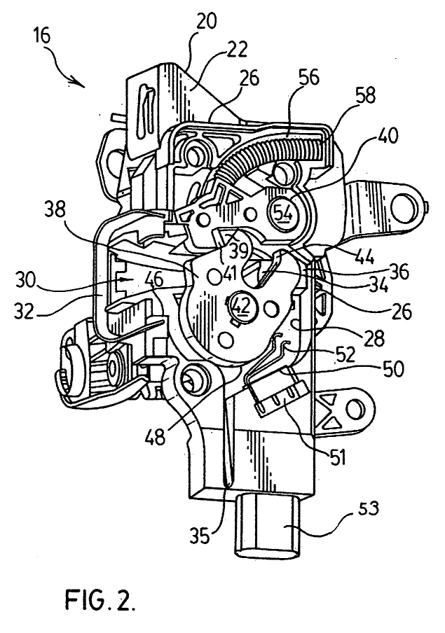

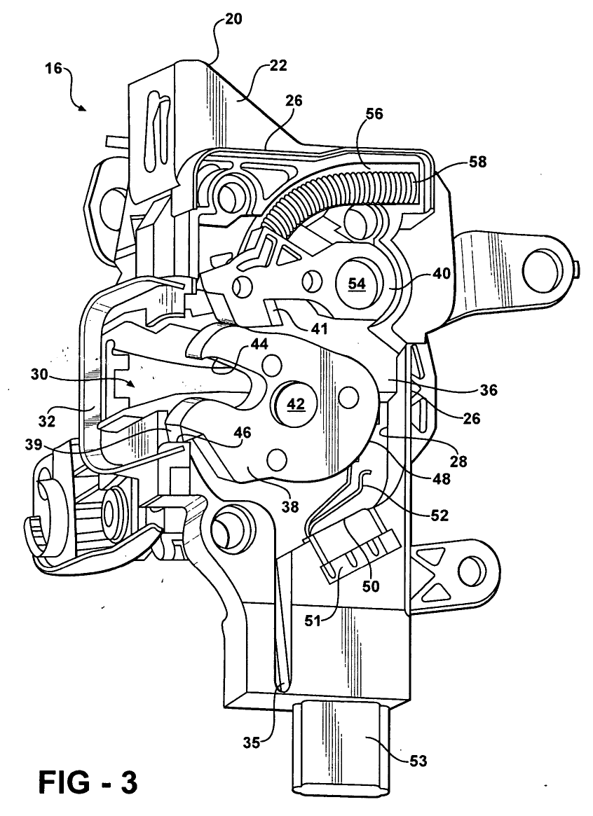

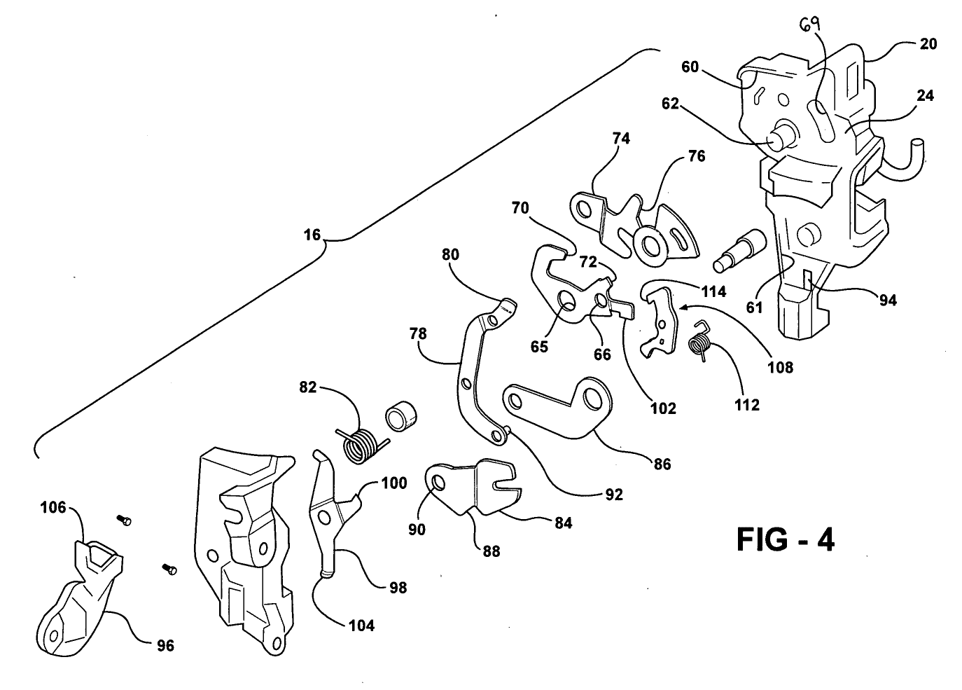

The latch assembly 16 includes a housing 20 having a first side 22, shown in FIGS. 2 and 3, and an opposing second side 24, shown in FIG. 4. Referring to FIGS. 2 and 3, a plurality of peripheral walls 26 extends along the first side 22 of the housing 30 and defines a cavity 28. A frusto-trapezoidal aperture 30 bisects the first side 22 of the housing 20. The aperture 30 is designed to receive the striker 18. A seal 32, preferably formed from a flexible rubber material, is mounted or otherwise integrally formed with the housing 20 at an open end of the aperture 30. An elastomeric or rubber bumper 34 including a shoulder 36 is fixedly mounted at an opposing end of the aperture 30 for receiving and absorbing the impact of the striker 18, thereby reducing stresses on the latch assembly 16 and reducing noise. A channel 35 extends from the cavity 28 of the first side 22 to the exterior of the housing 20 for providing a water outlet for the latch assembly 16.

A ratchet 38 and a pawl 40 are disposed within the cavity 28. The ratchet 38 and the pawl 40 are preferably constructed from metal and partially covered with a plastic material in order to reduce noise during latch operation. Certain portions that are subject to wear, such as a shoulder 39 of the ratchet 38 and a shoulder 41 of the pawl 40, are not covered by plastic.

The ratchet 38 is rotatably mounted to the first side 22 of the housing 20 via a pin 42 for movement between an engaged position, in which a hook portion 44 of the ratchet 38 engages the striker 18, and a release position, in which the ratchet 38 releases the striker 18 to allow opening of the door 14. A spring (not shown) biases the ratchet 38 into the release position. The angular travel of the ratchet 38 about the pin 42 is delimited by the shoulder 36 and a wall 46.

The ratchet 38 also includes a lip 48 for selectively engaging a switch 50 disposed within a recess 51 formed along the housing 20. More specifically, as the ratchet 38 moves from the engaged position to the release position, the lip 48 urges against a leaf spring 52 in order to change the state of the switch 50. The switch 50 includes a plurality of terminals attached to a wiring harness (not shown) that is disposed in and extends from a tubular construct 53 formed in the housing 20.

The pawl 40 is rotatably mounted along the first side 22 of the housing 20 via a pin 54. When the pawl 40 is in a pawl engagement position, as shown in FIG. 2, the pawl 40 retains the ratchet 38 in the engaged position. When the pawl 40 is moved out of the pawl engagement position, the ratchet 38 is free to move from the engaged position to the release position. A spring 56 is disposed within a groove 58 for biasing the pawl 40 into the pawl engagement position.

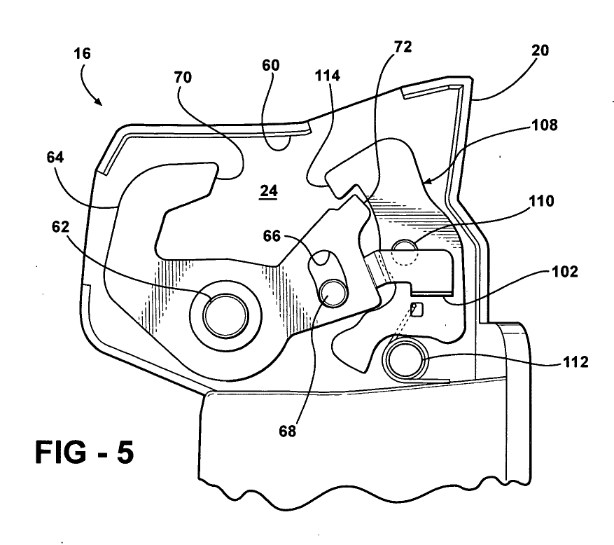

Referring to FIG. 4, the second side 24 of the housing 20 includes upper 60 and lower 61 cavities. A tubular post 62 is disposed within the upper cavity 60 and encompasses the pin 54 extending through the opposing first side 22 of the housing 20. An auxiliary pawl lever 64 is pivotally mounted about the tubular post 62. The auxiliary pawl lever 64 includes an aperture 65 for receiving the tubular post 62 therethrough. The auxiliary pawl lever also includes a slot 66 for receiving a projection 68, shown in FIGS. 5 through 7, of the pawl 40, which extends through an aperture 69 in the housing 20. Thus, the auxiliary pawl lever 64 is operably coupled to the pawl 40. The auxiliary pawl lever 64 also includes an abutment 70 and a protrusion 72.

Referring back to FIG. 4, an outside release lever 74 is also pivotally mounted about the tubular post 62. The outside release lever 74 includes a slot 76 and is coupled to the auxiliary pawl lever 64 by a slidable link 78. The slidable link 78 includes a tab 80 that slides in and out of the slot 76. A toggle spring 82 biases the link 78 either into or out of the slot 76. When the tab 80 is adjacent an open end of the slot 76, the link 78 is in the unlocked position. When the link 78 is in the unlocked position, rotation of the outside release lever 74 causes the tab 80 to engage the auxiliary pawl lever 64 so that the auxiliary pawl lever 64 rotates. Since the pawl 40 is coupled to the auxiliary pawl lever 64, rotation of the auxiliary pawl lever 64 causes the pawl 40 to move out of the pawl engagement position. As a result of this rotation, the ratchet 38 moves to the release position and releases the striker 18. On the other hand, when the tab 80 is adjacent a closed end of the slot 76, the link 78 is in the locked position. When the link 78 is in the locked position, the outside release lever 74 will rotate relative to the auxiliary pawl lever 64 and the ratchet 38 remains in the engaged position.

The link 78 is actuated by a lock link lever 84, which in turn is actuated by a key cylinder lever 86 connected to a key cylinder (not shown). The lock link lever 84 includes a shelf 88 with side ridges. The key cylinder lever 86 is seated in the shelf 88 and has an angular freedom of motion of about 20 degrees (“lost motion”) before the key cylinder lever 86 engages one of the side ridges and imparts rotational motion to the lock link lever 84. The lock link lever 84 also includes an aperture 90, which receives a coupling projection 92 depending from the link 78. As a result, the link 78 is kinematically coupled to the lock link lever 84 and the key cylinder lever 86. Consequently, only a full rotation of the key cylinder lever 86 causes the link 78 to move between the locked and unlocked positions. A switch 94 is capable of indicating any of three positions of the key cylinder: neutral, unlock and lock.

An inside lock lever 96 and an inside release lever 98 are coupled to the key cylinder lever 86 and the auxiliary pawl lever 64, respectively. More specifically, the inside release lever 98 includes a foot 100 that abuts an appendage 102 of the auxiliary pawl lever 64. The inside release lever 98 also includes a toe 104 for engaging a pedal 106 of the inside lock lever 96 in order to unlock the inside lock lever 96 when the inside release lever 98 is actuated.

Referring to FIGS. 5 through 7, the latch assembly 16 includes an inertia catch, generally indicated at 108, for preventing the ratchet 38 from releasing the striker 18 in the event of a sudden acceleration above a predetermined threshold. In the current embodiment, the inertia catch 108 is an inertia lever having a predetermined mass and rotatably mounted about a pin 110 for movement in and out of a rest position, shown in FIG. 5. The inertia lever 108 is biased into the rest position by a spring 112.

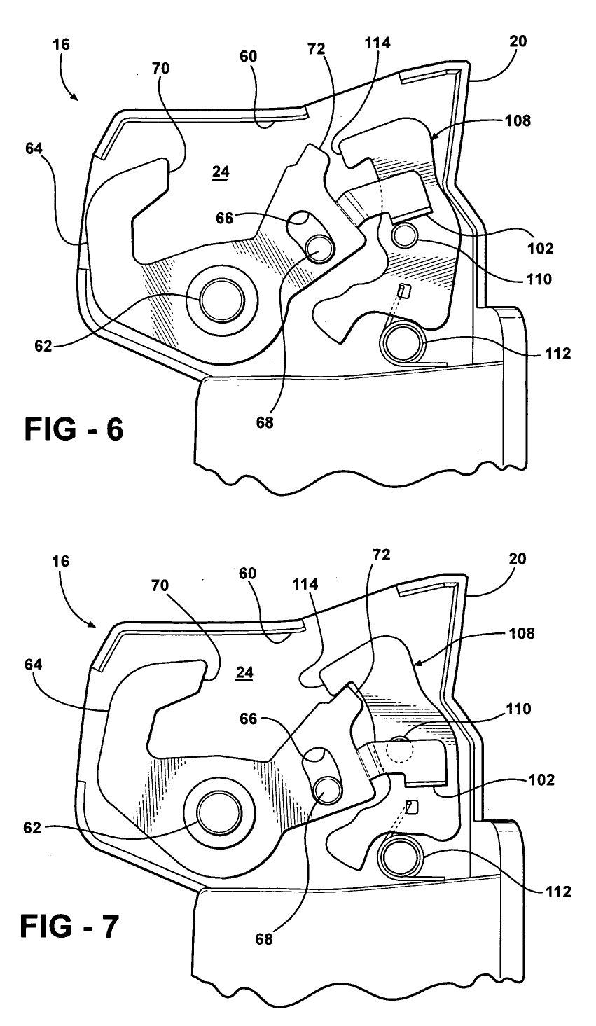

The inertia lever 108 includes a lip 114 that selectively engages the protrusion 72 of the auxiliary pawl lever 64. In normal operation of the latch assembly 16, i.e., when the outside 74 or inside 98 release levers are actuated, the auxiliary pawl lever 64 and the inertia lever 108 pivot about the respective tubular post 62 and pin 110 at approximately the same rate such that the protrusion 72 clears the lip 114, as shown in FIG. 6. As a result, the auxiliary pawl lever 64 urges the pawl 40 out of the pawl engagement position, which causes the ratchet 38 to move into the release position and release the striker 18.

In the event of a motor vehicle impact, the auxiliary pawl lever 64 will rotate at a very fast rate. But due to the mass of the inertia lever 108, the rotation of the inertia lever 108 lags behind the rotation of the auxiliary pawl lever 64. As a result, the lip 114 engages the, protrusion 72, as shown in FIG. 7, to stop the rotation of the auxiliary pawl lever 64. Therefore, the pawl 40 does not move out of the pawl engagement position and the ratchet 38 remains in the engaged position. As a result, the striker 18 is not released and the door 14 does not inadvertently open from the motor vehicle impact.

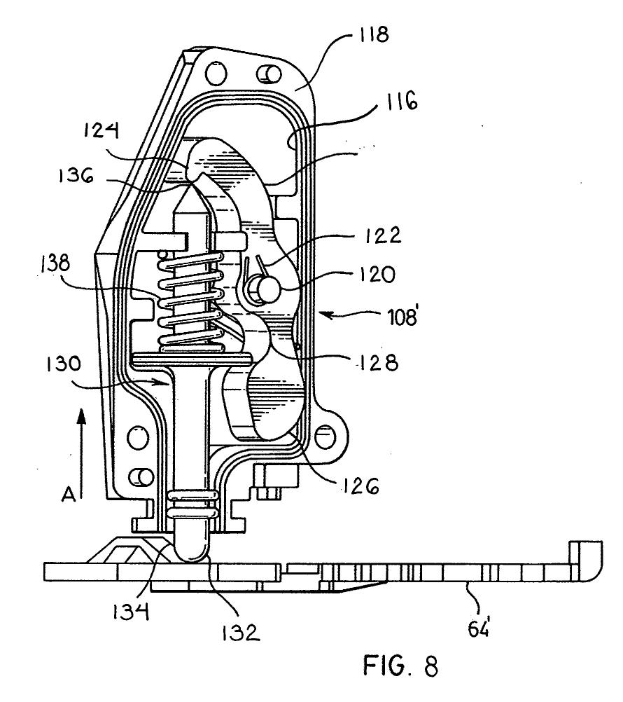

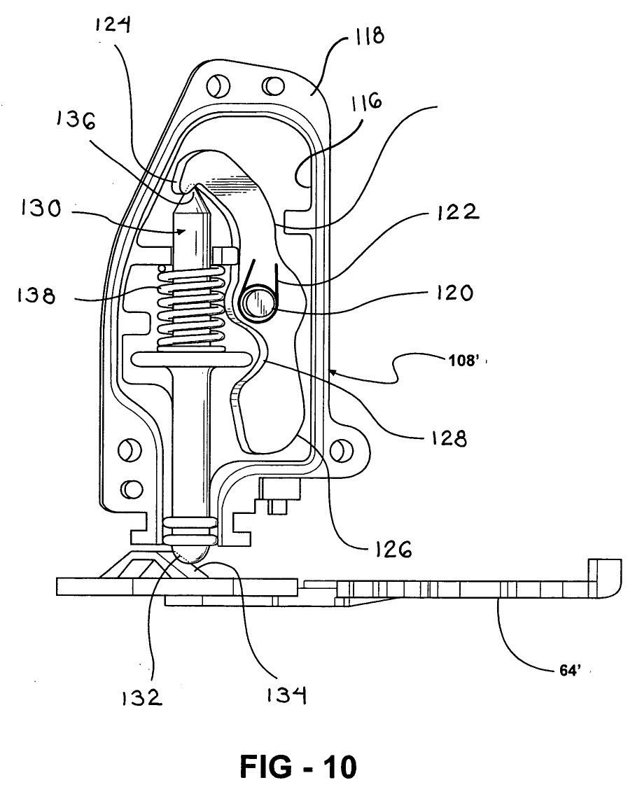

Referring to FIGS. 8 through 10, wherein like primed reference numerals represent similar elements as those described above, the inertia lever 108′ according to a second embodiment of the invention is disposed within a cavity 116 of a housing member 118. The inertia lever 108′ has a predetermined mass and is rotatably mounted to a pin 120 for movement in and out of a neutral position, shown in FIG. 8. A torsion spring 122 is disposed around the pin 120 for biasing the inertia lever 108′ into the neutral position. The inertia lever 108′ includes a hook 124, a distal end 126 opposite the hook 124, and a curved surface 128.

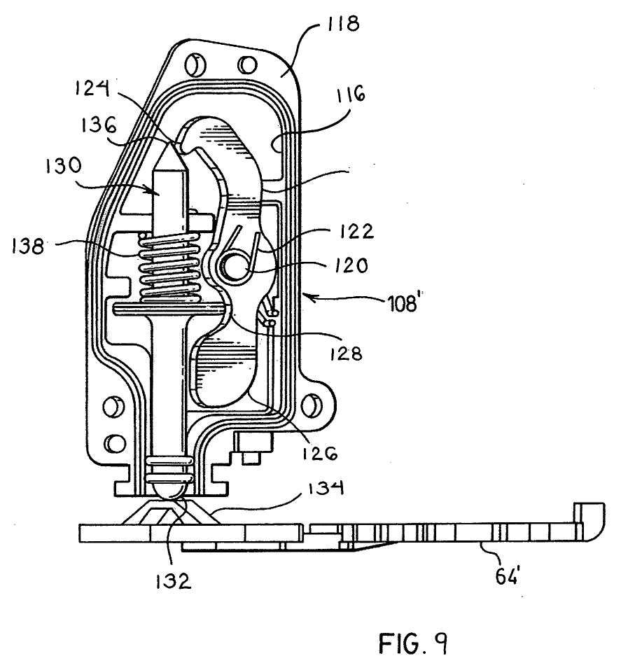

A plunger 130 is disposed within the cavity 116 of the housing member 118 for selective engagement with the inertia lever 108′. The plunger 130 includes a first end 132 that abuts a ramp 134 of the auxiliary pawl lever 64′. The first end 132 is preferably rounded to allow for travel of the plunger 130 up and down the ramp 134 between a rest position, shown in FIG. 8, and an extended position, shown in FIG. 9. The plunger 130 also includes a second end 136 that abuts the hook 124 of the inertia lever 108′.

During normal operation, the auxiliary pawl lever 64′ is rotated as one of the outside 74′ and inside 98′ release levers is actuated. The rotation of the auxiliary pawl lever 64′ urges the first end 132 of the plunger 130 up the ramp 134 against the bias of a spring 138, which in turn pushes the second end 136 of the plunger 130 in the direction of arrow A, shown in FIG. 8, against the hook 124. As the plunger 130 moves in the direction of arrow A, it urges rotation of the inertia lever 108′ about the pin 120. As a result, the second end 136 of the plunger 130 and the hook 124 roll against one another at approximately the same rate such that the second end 136 of the plunger 130 clears the hook 124 and reaches the extended position, as shown in FIG. 9. Thus, the auxiliary pawl lever 64′ is able to rotate past the first end 132 of the plunger 130 to urge the pawl 40′ out of the pawl engagement position, which allows the ratchet 38′ to move into the release position.

In the event of a motor vehicle impact, the plunger 130 is quickly forced in the direction of arrow A, shown in FIG. 8. But due to the mass of the inertia lever 108′, the rotation of the inertia lever 108′ lags behind the movement of the plunger 130. As a result, the hook 124 engages the second end 136 of the plunger 130, which stops the first end 132 from moving up the ramp 134 and prevents the rotation of the auxiliary pawl lever 64′. Therefore, the pawl 40′ is not able to move out of the pawl engagement position, which in turn prevents the ratchet 38′ from moving to the release position.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A latch assembly selectively engaging a striker for latching a door to a motor vehicle body, said latch assembly comprising:
a housing;
a ratchet rotatably mounted to said housing for movement between an engaged position engaging the striker and a release position;
a pawl rotatably mounted to said housing and engageable with said ratchet to retain said ratchet in said engaged position; and
an inertia catch coupled to the housing and operably connected to said pawl for preventing said pawl from moving out of engagement with said ratchet in the event of a motor vehicle impact.

2. A latch assembly as set forth in claim 1 including an auxiliary pawl lever rotatably mounted to said housing for moving said pawl out of engagement with said ratchet to allow said ratchet to move from said engaged position to said release position.

3. A latch assembly as set forth in claim 2 wherein said inertia catch is an inertia lever having a lip engageable with said auxiliary pawl lever.

4. A latch assembly as set forth in claim 3 wherein said pawl includes a projection extending out therefrom.

5. A latch assembly as set forth in claim 4 wherein said auxiliary pawl lever includes a slot receiving said projection therethrough to couple said auxiliary pawl lever to said pawl.

6. A latch assembly as set forth in claim 5 wherein said auxiliary pawl lever includes a protrusion selectively engageable with said lip.

7. A latch assembly as set forth in claim 2 including a plunger movable between a rest position, in which said plunger abuts said inertia catch, and an extended position, in which said plunger clears said inertia catch to allow said auxiliary pawl lever to move said pawl out of engagement with said ratchet.

8. A latch assembly as set forth in claim 7 wherein said pawl includes a projection extending out therefrom.

9. A latch assembly as set forth in claim 8 wherein said auxiliary pawl lever includes a slot receiving said projection therethrough to couple said auxiliary pawl lever to said pawl.

10. A latch assembly as set forth in claim 9 wherein said inertia catch includes a hook engageable with said plunger in the event of a motor vehicle impact to prevent said plunger from moving from said rest position to said extended position.

11. A latch assembly as set forth in claim 10 wherein said inertia lever includes a curved portion for providing clearance to said plunger during movement between said rest and extended positions.

12. A latch assembly selectively engaging a striker for latching a door to a motor vehicle body, said latch assembly comprising:
a housing;
a ratchet rotatably mounted to said housing for movement between an engaged position engaging the striker and a release position;
a pawl rotatably mounted to said housing and engageable with said ratchet to retain said ratchet in said engaged position;
an auxiliary pawl lever rotatably mounted to said housing and operably coupled to said pawl for moving said pawl out of engagement with said ratchet; and
an inertia lever rotatably mounted to said housing and having a lip engageable with said auxiliary pawl lever in the event of a motor vehicle impact to prevent said auxiliary pawl lever from moving said pawl out of engagement with said ratchet.

13. A latch assembly as set forth in claim 12 wherein said auxiliary pawl lever includes a protrusion extending out therefrom and engageable with said lip.

14. A latch assembly selectively engaging a striker for latching a door to a motor vehicle body, said latch assembly comprising:
a housing;
a ratchet rotatably mounted to said housing for movement between an engaged position engaging the striker and a release position;
a pawl rotatably mounted to said housing and engageable with said ratchet to retain said ratchet in said engaged position;
a plunger operably coupled to said pawl and movable between a rest position and an extended position in which said pawl is moved out of engagement with said ratchet to allow said ratchet to move into said release position; and
an inertia lever engageable with said plunger in response to a motor vehicle impact for preventing said plunger from moving into said extended position.

15. A latch assembly as set forth in claim 14 including a spring for biasing said plunger into said rest position.

16. A latch assembly as set forth in claim 15 including an auxiliary pawl lever rotatably mounted to said housing and coupled to said pawl.

17. A latch assembly as set forth in claim 16 wherein said auxiliary pawl lever includes a ramp receiving said plunger thereagainst.

18. A latch assembly as set forth in claim 17 wherein said inertia lever has a curved portion for providing clearance to said plunger as said plunger moves between said rest and extended positions.
